(19) United States
(12) Patent Application Publication
(10) Pub. No.: US 2024/0085597 A1
(43) Pub. Date: Mar. 14, 2024

(54) SYSTEM AND METHOD FOR PLASMONIC SPECTRAL CONVERSION USING NANO-HOLES AND NANO-DISKS

(71) Applicant: SunDensity, Inc., Boston, MA (US)

(72) Inventor: Nishikant Sonwalkar, Boston, MA (US)

(21) Appl. No.: 18/463,452

(22) Filed: Sep. 8, 2023

Related U.S. Application Data
(60) Provisional application No. 63/405,637, filed on Sep. 12, 2022.

(51) Int. Cl. G02B 5/00; G02B 27/00

(52) U.S. Cl. CPC G02B 5/008; G02B 27/0012; G02B 2207/101

(57) ABSTRACT

A photonic surface has a thin film layer having an array of nano-holes formed within a material, wherein the nano-holes are uniformly dimensioned and distributed to enhance plasmonic response of the material over a range of wavelengths.

### CROSS REFERENCE TO RELATED APPLICATIONS

The present application claims the benefit of U.S. Provisional Application Ser. 63/405,637 entitled “SYSTEM AND METHOD FOR PLASMONIC SPECTRAL CONVERSION USING NANO-HOLES AND NANO-DISKS by Nishikant Sonwalkar, filed 12 Sep. 2022 and incorporated herein in its entirety.

### STATEMENT OF GOVERNMENT INTEREST

Subject matter disclosed herein was partially supported by National Science Foundation (NSF SBIR 201481). The government may have certain rights in the claimed invention.

### TECHNICAL FIELD

This invention generally relates to photonic optical coatings and more particularly to a methodology and process for providing coatings formed using nano-holes and nano-disks that exhibit enhanced plasmonic response to photon flux.

### BACKGROUND ART

Nanoparticles have been shown effective for enhancing plasmonic interaction of thin-film surfaces, such as by substantially increasing the surface area of metals that support plasmonic behavior. Research over the past 30 years has revealed that nanoparticles of silver (Ag) and gold (Au) can be particularly useful for Raman spectroscopic observation of organic molecules. Surface plasmonic resonance appears to be induced from incoming electromagnetic radiation with localization of the electric field as a result of the interaction of light with nanoparticles of various shapes, such as with spherical, oblate or prolate shapes, with appropriate spatial distributions, and with different size parameters.

Nano-disks are nanoparticle structures that may provide some measure of improved performance for photonic response. In addition to these features, observations have been made of extraordinary optical transmission in arrays of holes, appropriately dimensioned, perforated in Ag films. There has been increased interest in theoretical and experimental exploration of these features as regular plasmonic nanostructures exhibiting resonant optical properties. Interest in such nanostructures relates to their ability to exhibit high-Q narrowband collective lattice resonances, also referred to as surface lattice resonances or (quasi)guided mode resonances. These collective resonances, emerging due to Fano-type hybridization between discrete states associated with the periodicity of the structure, and broadband resonances excited on constituent scatterers, have found use in lasing, sensing, nonlinear optics, fluorescence enhancement, up-conversion, and other applications. Nano-disks and nano-holes have shown promise for achieving highly efficient narrowband transmission, reflection, or absorption.

Apart from recently emerged utilization of all-dielectric nanoparticles for lattice resonance, most of the work in this field considers arrays of metal nanoparticles of different shapes: disks, spheres, hemispheres, cones, pillars, mushrooms, crescents and other exotic shapes. The choice of nanoparticles is mostly justified by the intuitive understanding of the behavior of such arrays via closed-form analytical solutions and by the number of existing manufacturing processes of nanocrystals. For instance, optical properties of a single nanoparticle can be almost perfectly described within the framework of the modified long-wavelength approximation which, being combined with the coupled dipole approximation, yield results perfectly fitting both full-wave simulations and experiments.

Complementary arrays of nano-holes can be manufactured by methods such as focused ion beam milling, soft interference lithography, ion-beam planarization, or direct laser writing. However, such nanostructures are rarely studied since they can be treated analytically only in the case of nano-holes perforated in perfectly-conducting thin films using Babinet's principle and using known analytical solutions for complementary, perfectly conducting disks. For realistic materials with losses, one inevitably has to employ full-field methods and brute-force simulations to study optical properties of nano-holes perforated in metal films, which can be time-consuming and does not provide any insights into the underlying physics. As a result of these inherent difficulties, nano-holes have not been widely studied; rarely one can find a direct comparison between optical properties of arrays of nanoparticles and complementary arrays of nano-holes.

The Applicant, recognizing the need for improved plasmonic response in photonic thin-film structures, has developed approaches and structures that take advantage of both nano-disk and nano-hole distributions, or combinations of nano-disk and nano-hole distributions, for optimizing the electric field interactions that enhance plasmonic response in photonic applications.

### SUMMARY OF INVENTION

It is an object of the present disclosure to advance the art of photonic thin-film design. With this object in mind, embodiments of the present disclosure provide a photonic surface comprising a thin film layer having an array of nano-holes formed within a material, wherein the nano-holes are uniformly dimensioned and distributed to enhance plasmonic response of the material over a range of wavelengths.

### INDUSTRIAL APPLICABILITY

Products and services that can use materials designed using the disclosed methodology can include solar PV (photo-voltaic) panels, low-emissivity glass and window glass, building integrated PV, greenhouse glass with spectral management for crop growth, light sensors, and sub-wavelength optics with plasmonic components and surfaces, for example.

### BRIEF DESCRIPTION OF DRAWINGS

FIG. 1 is a schematic diagram that shows parameters for nano-disk and nano-hole arrays.

FIG. 2A is a graph showing the values of holes of diameter Dₕ as a function of disk diameter, D_{d}, and pitch P, with P/D_{d} ratio.

FIG. 2B shows a table of exemplary parameters for nano-hole and nano-disks configurations shown in following FIGS. 3A, 4A, and 5A.

FIG. 3A is a graph that shows optical properties of regular arrays of NDs and complementary arrays of NHs for square arrays of nano-disks and complementary arrays of nano-holes in the D_{d}=Dₕ case.

FIG. 3B shows an inset to FIG. 3A comparing ND and NH parameters.

FIG. 4A is a graph that shows absorption, reflection, and transmission as arranged in FIG. 3A, wherein the nano-hole diameters Dₕ are substantially equal to the pitch P.

FIG. 4B shows an inset to FIG. 4A comparing ND and NH parameters.

FIG. 5A is a graph that shows absorption, reflection, and transmission as arranged in FIG. 3A, wherein the surface area covered by metal is the same for both arrays of holes and disks.

FIG. 5B shows an inset to FIG. 5A comparing ND and NH parameters.

FIG. 6A shows transmittance and reflectance spectra for square arrays of PEC nano-disks (solid lines) and for arrays of holes for the Dₕ=D_{d} case.

FIG. 6B shows transmittance and reflectance spectra for square arrays of Ag thin-film nano-disks (solid lines) and for arrays of holes for the Dₕ=D_{d} case.

FIG. 6C shows transmittance and reflectance spectra for square arrays of Au thin-film nano-disks (solid lines) and for arrays of holes for the Dₕ=D_{d} case.

FIG. 7A shows a magnified view of an array of nano-holes in nickel.

FIG. 7B shows performance results for nano-holes in nickel.

FIG. 8A shows a magnified view of an array of nano-holes in copper.

FIG. 8B shows performance results for nano-holes in copper.

FIG. 9 is a schematic side view that shows a photonic film formed using a layer of nano-hole features.

FIG. 10 is a set of schematic views that show parameters used in the numerical methodology applied in the present disclosure for dimensioning and distribution of NP and NH features to provide and manage spectral shifting.

FIG. 11 is a logic flow diagram that shows a process for nanostructure design for managing spectral shifts.

FIG. 12 is a logic flow diagram that shows stages in the design process for obtaining spectral shifting.

### DESCRIPTION OF EMBODIMENTS

Figures shown and described herein illustrate key principles of operation and fabrication according to various embodiments and are not drawn with intent to show actual size or scale. Some visual exaggeration may be necessary in order to emphasize basic structural relationships or principles of operation.

In the context of the present disclosure, terms “top” and “bottom” or “above” and “below” are relative and do not indicate any necessary orientation of a component or surface, but are used simply to refer to and distinguish opposite surfaces or different light paths within a component or block of material. Similarly, terms “horizontal” and “vertical” may be used relative to the figures, to describe the relative orthogonal relationship of components or light in different planes, for example, but do not indicate any required orientation of components with respect to true horizontal and vertical orientation.

Where they are used, the terms “first”, “second”, “third”, and so on, do not necessarily denote any ordinal or priority relation, but are used for more clearly distinguishing one element or time interval from another. For example, there are no fixed “first” or “second” elements in what is taught herein; these descriptors are merely used to clearly distinguish one element from another similar element in the context of the present disclosure.

In the context of the present disclosure, the term “film” can be used to mean a coating that is applied to a substrate as one or more thin layers, such as a thin-film optical coating formed from successively formed layers of materials treated to have different indices of refraction. A film can also be a sheet of a light-propagating substrate formed of one or more layers of optical materials and used in standalone fashion or optically coupled to another optical component, such as using an adhesive. The thickness of a film can vary over a range; the behavior of an optical film is primarily related to its treatment of, or response to, light incident on the broad, 2-dimensional surface of the film.

As used herein, the term “energizable” relates to a device or set of components that perform an indicated function upon receiving power and, optionally, upon receiving an enabling signal.

Noble metal (such as Silver, Gold) nanoparticles have found numerous applications for modifying and enhancing plasmonic response to photon flux, characteristically increasing or decreasing one or more of reflection, transmission, or absorption. Embodiments of the present disclosure develop methods for obtaining additional performance using nano-holes NH as nanostructures for exhibiting plasmonic behavior. Further embodiments of the present disclosure use nano-disks (ND) and other types of nanoparticles (NP) in addition to nano-holes for spectral shifting and other plasmonic behavior. According to an embodiment of the present disclosure, a combination of nano-disks or other types of nanoparticles (NP) and nano-holes (NH) can be formed using the same layer. As the term implies, nano-disks are broadly disk-shaped, having diameter measurements (measured along, or parallel to, the plane of the photonic surface) that significantly exceed thickness measurements (measured orthogonal to the plane); for example, the diameter can be 2 or more times the thickness, such as from 10-15 times the thickness. Diameter is the largest nm dimension of the nano-disk.

A plasmonic effect is an optoelectronic effect in which free electrons in a metal collectively oscillate in response to external light. This effect appears to occur as the result of a resonance phenomenon in which most of the light energy of incident light having a certain wavelength is shifted to free electrons. The resonance phenomenon occurs between a metal having a negative dielectric constant and a high conductivity and a general insulator material having a positive dielectric constant. When the frequency of incident light equals the natural frequency of the surface plasmon of a metal, most of the incident light is absorbed.

Plasmons are oscillations of free electrons that are the consequence of the formation of a dipole in the material due to electromagnetic waves. The electrons migrate in the material to restore its initial state; however, the light waves oscillate, leading to a constant shift in the dipole that forces the electrons to oscillate at the same frequency as the light. This coupling only occurs when the frequency of the light is equal to or less than the plasma frequency and is greatest at the plasma frequency that is therefore called the resonant frequency. The scattering and absorbance cross-sections describe the intensity of a given frequency to be scattered or absorbed.

With regard to metal nanoparticles, the electric field of visible light or near-infrared light may be paired with a plasmon to enhance light absorption, thereby achieving a vivid color, for example. This is one possible effect of surface plasmon resonance, with local formation of a highly increased electric field as light energy is transformed by a surface plasmon and is accumulated on the surfaces of metal nanoparticles. This also permits optical control over a region smaller than the diffraction limit of light.

Metal nanoparticles strongly and distinctively interact with an electromagnetic wave due to, for example, the surface plasmon resonance phenomenon, and thus the light absorption band may be amplified and controlled.

Metal nanoparticles exhibiting plasmon resonance are particles whose electron density can couple with electromagnetic radiation of wavelengths that are far larger than the particle due to the nature of the dielectric-metal interface between the nanoparticles and the medium in which the nanoparticles are disposed. Metal nanoparticles having plasmon resonance can exhibit interesting and useful scattering, absorbance, and coupling properties based on their geometries and relative positions.

The Applicant has investigated the alternative use of nano-holes, formed within and along a deposited metal surface, for exhibiting the transmittance/reflection/absorption properties that can be manipulated to generate and manage plasmonic response for light over particular wavelengths. Nano-holes have the same sub-wavelength dimensional range as nanoparticles in general, generally defined as hollow entities having one or more external dimension (height or thickness, and diameter, or length and width) not exceeding about 100 nm. The nano-hole diameter is considered with respect to the plane of the material that has been removed, that is, diameter (or length and width) is measured parallel to the surface of the corresponding thin film layer; the height of a nano-hole relates to the thickness or height of the bounding material within which the nano-hole cavity is formed and is measured in the direction normal to the surface of the corresponding thin film layer. For plasmonic enhancement, uniform dimensions and spacing or pitch are needed for arrays of nano-holes and of nanoparticles in general, with uniformity within tolerances reasonably achievable using photonic fabrication and with sufficient uniformity for achieving measurable enhancements in performance due to plasmonic effects. This can mean, for example, that, on average, pitch P is uniform to within +/−3 nm or less.

The dimensional, distribution (pitch) and material characteristics of the nano-hole determine the specific plasmonic performance that is obtained where an array of nano-holes is provided. The Applicant presents some example data in the subsequent description; however, there can often be the need to model and experiment with materials and dimensions in order to obtain the desired performance enhancements at different wavelengths or when used in combination with other photonic components, for example.

The solar spectrum ranges in wavelengths from 150 nm to 4000 nm. The energy contained in the solar spectrum is 1000 W/m². An optical film can provide down-conversion of UV (ultraviolet) energy into the near infra-red (NIR) spectrum for use in optoelectronic sensors and converters. Down-conversion can be achieved by absorption of UV energy of the solar spectrum using metal nano-particles such as nano-disks as well as by using nano-holes. The use of quantum-confined nano structures enables quantum redistribution, by which large photons having energies >3 eV can be spectrally shifted to generate three 1 eV photons.

Electrons of photoluminescent material can be excited to a higher energy state by high-energy UV photons. The particles can then dissipate into lower energy as they are conveyed through an array of subwavelength nano-holes NH. The subwavelength holes can be formed using laser ablation methods, soft-interference lithography, ion-beam planarization, or FIB (focused ion beam milling) or other suitable technique. The subwavelength nano-holes or comparably sized and distributed nano-disks, provide the quantum confinement needed for “quantum cutting” of high energy photons into multiple low energy photons, and can act as antennae for the optoelectronic sensors.

The Applicant, recognizing the need for improved plasmonic response in photonic thin-film structures, has developed approaches and structures that take advantage of both nano-disk and nano-hole distributions, or combinations of nano-disk and nano-hole distributions including interspersed nano-disk/nano-hole configurations, for optimizing the electric field interactions that enhance plasmonic response in photonic elements and applications.

Plasmonic spectral enhancement results from the increased electrical field in the dielectric matrix as it interacts with electromagnetic radiation. This effect can be used for management of spectral shifting in a range of optical applications.

According to an embodiment of the present disclosure, a combination of nano-disks or other types of nanoparticles (NP) and nano-holes (NH) can be formed using the same layer. For plasmonic enhancement, the NPs and NHs have diameter that is less than the wavelength of the incident electromagnetic radiation energy.

An embodiment of the present disclosure can be, for example, a film or surface conditioned using an array of nano-holes, or one or more arrays of nano-holes in combination with nano-disks, thereby effecting various rearrangements of light energy for incident light.

A numerical FDTD (Finite Difference Time-Domain), used for modeling and generating approximate solutions to systems of differential equations in electronic field behavior, such as computational electrodynamics, can be utilized for the design of nanoparticle and nano-hole matrices that effect spectral shifting. Various computational software tools are commercially available to provide FDTD to the task of nanoparticle design for spectral response.

The Applicant has followed an approach for enhancing plasmonic performance by forming 2D arrays of circular nano-holes NH in metal films, with near- and far-field properties similar to that of regular 2D arrays of nano-disks ND having the same diameter (or corresponding dimensions along the plane of the surface) and having equivalent periodicity (pitch). The underlying principle is to design substantially circular nano-holes with sizes corresponding to inter-particle cavities in corresponding arrays of nano-disks. Full-wave simulations for Ag nano-disks ND and respectively engineered complementary arrays of nano-holes NH demonstrate minor differences between near and far-field properties, either at wavelengths corresponding to Wood-Rayleigh anomalies of the arrays or in a broad wavelength range, depending on the array periodicity. The Applicant's approach has broad implications in plasmon-enhanced-driven applications, including optoelectronic and photovoltaic devices, wherein fabrication of nano-hole arrays can have advantages over fabrication only using NPs themselves.

For plasmonic enhancement, the NPs and NHs have diameters over a range of values, wherein the diameters are less than the wavelength of the incident electromagnetic radiation energy. NH and ND diameters can be the same, or may be varied across a surface. Similarly, ND and NH spacing distances can be uniform on a particular surface or may be arranged using some pattern that enhances spectral control.

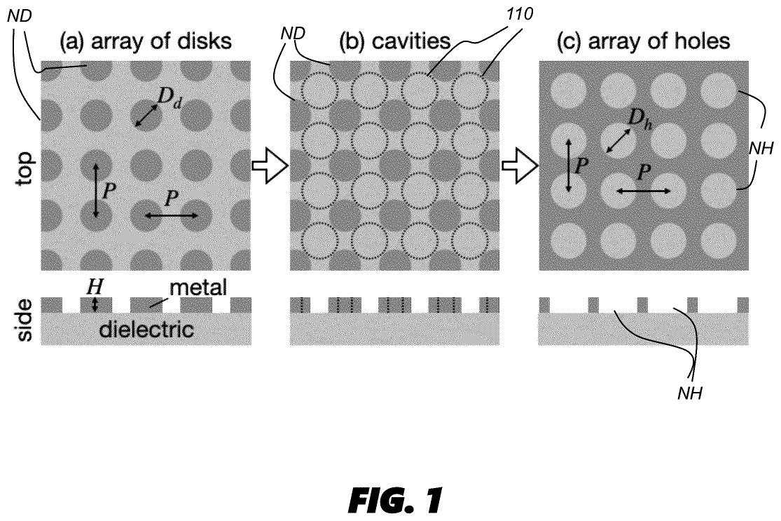

The schematic diagrams of FIG. 1 show various types of nanostructures, formed on a dielectric substrate, that can be used to enhance plasmonic behavior. At (a) in FIG. 1, top and side views show an array of nano-disks ND formed with a diameter D_{d}, considered along the plane of the surface, and arranged in a square lattice with pitch P. FIG. 1 part (b) shows circular interparticle cavities 110 formed between the nano-disks ND.

At (c) in FIG. 1 there is shown a square array of nano-holes NH having diameter:

Dₕ=\sqrt{2}P−D_{d} (1)

Notably, then, diameters D_{d} and Dₕ, for nano-disks ND and nano-holes NH respectively, are not the same dimension in this example.

It is useful to notice from FIG. 1 parts (a) and (c) that a complementary array of NHs will necessarily have similar pitch, P, as the initial array of NDs, thus spectral position of WRAs (Wood-Rayleigh anomalies) for normal incidence,

$${A}_{p , q} = n \frac{P}{\sqrt{{p}^{2} + {q}^{2}}} \qquad ( 2 )$$

are preserved to maintain major resonant features inherent to lattice resonances. Here n is the refractive index of the medium surrounding the nanoparticles, and p and q are integers corresponding to the orders of diffraction in orthogonal directions within the plane of the array. Integers p and q are interchangeable for square arrays considered in this work, i.e. A_{p,q}=A_{q, p}. Noticeably, in a half space geometry, two sets of WRAs emerge: in the substrate and in the superstrate with respective values of the refractive index, n (Eq. 2). The Wood-Rayleigh anomaly (alternately termed Wood or Rayleigh-Wood anomaly) relates to surface response with diffracted light directed perpendicular to diffractive surface features, causing interaction with surface plasmon polariton waves and forming a localized optical field.

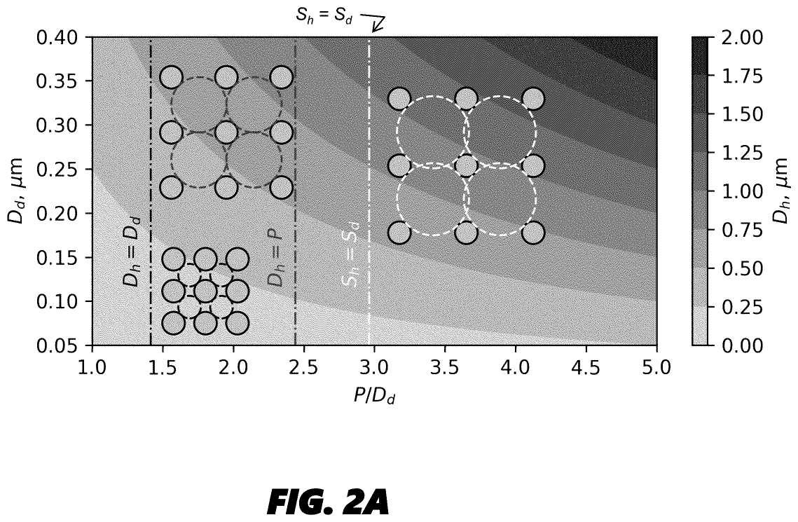

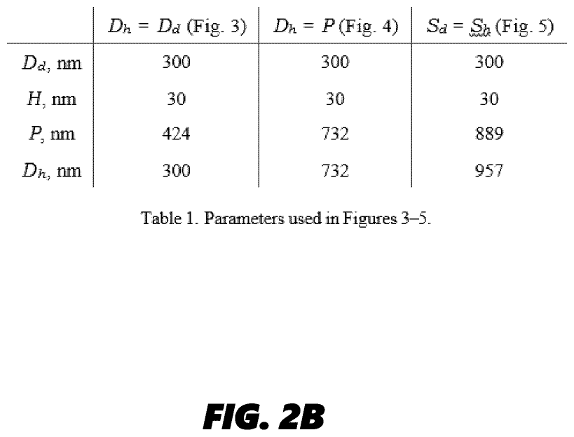

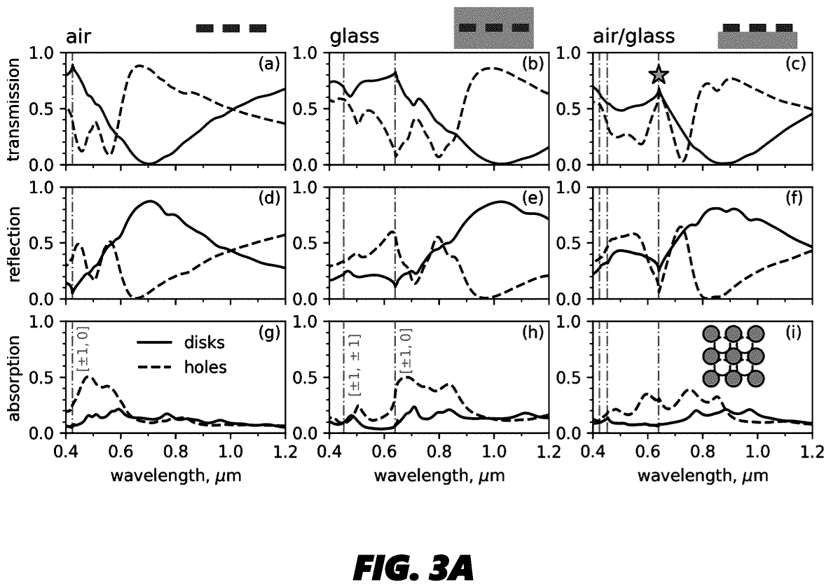

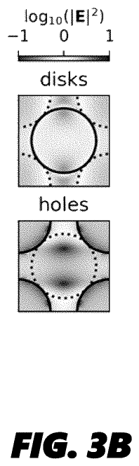

FIG. 2A demonstrates the values of nano-holes diameter, Dₕ, according to Eq. (1) as a function of disk diameter, D_{d}, and P/D_{d} ratio. Vertical dashed lines in the FIG. 2A graph correspond to three cases described subsequently with reference to FIGS. 3A-5B.

Regimes particularly worth more careful consideration include:
(i) disks and holes with the same diameter (Dₕ=D_{d}), which has been examined in “disks or holes” comparative studies. In this case,

$${D}_{d} = {D}_{h} = \frac{\sqrt{2} P}{2} ;$$

(ii) touching complementary holes, i.e. Dₕ=P, which occurs when: D_{d}=(\sqrt{2}−1)P;
(iii) arrays of disks and holes, both having the same surface area S covered with a metal, S_{d}=Sₕ.

In a unit cell Sₚ=P², area occupied by a nano-disk, surface area

S_{d}=n0.5Dₕ²

is the same as the surface area Sₕ covered by metal in a complementary hole array

Sₕ=P²n0.5Dₕ²

Notice that hole diameter Dₕ in this case is slightly larger than the pitch P:

Dₕ 1.0767P,

thus holes can slightly overlap as shown to the right side in FIG. 2A.

In what follows, the diameter and height of nano-disks (NDs) is set to D_{d}=300 nm and H=30 nm, respectively. Pitches and hole sizes can vary accordingly, as shown in Table 1 of FIG. 2B.

FIGS. 3A, 4A and 5A show optical properties of regular arrays of Ag NDs and complementary arrays of NHs in thin film with three different configurations of the host medium:
(i) air host with n=1;
(ii) glass host with n=1:51; and
(iii) air/glass half-space.

Values for nano-disks ND are shown in solid lines; values for nano-holes NH are shown in dashed lines in FIGS. 3A, 4A, and 5A. The reflectance and transmittance spectra of the nanostructures are calculated using a commercially available Finite-Difference Time-Domain (FDTD) software package. For modeling, nanostructures are illuminated by a plane wave with normal incidence (along the z axis) and polarization along the x axis (FIG. 1). In the air-glass example, incident illumination is from the glass side. Perfectly matched layer boundary conditions are used on the top and bottom sides, while the periodic boundary conditions are applied at the lateral boundaries of the simulation box. An adaptive mesh is used to accurately reproduce the nano-disk ND and nano-hole NH shapes. The tabulated values of dielectric constants of Ag are used in simulations.

FIG. 3A shows transmission T, reflection R, and absorption A spectra for square arrays of nano-disks (solid lines) and complementary arrays of nano-holes (dashed lines) in the D_{d}=Dₕ case. Vertical lines indicate spectral positions of the WRAs, A_{p,q} in air and glass. The combined set of WRAs (both for air and for glass media) is shown in the right column for the air/glass configuration. The inset of FIG. 3B shows electric field intensity |E|² within the unit cell of ND and NH arrays for the air/glass host at A_{+1,0}^{glass}=640 nm in air/glass half-space (see star symbol at (c) in FIG. 3A).

In the exemplary case of FIG. 3A, with Dₕ=D_{d}, an accurate illustration of Babinet's principle can clearly be observed. Due to relatively large absolute values of the real part of dielectric permittivity of Ag for visible and near-IR (NIR) wavelengths, behavior is nearly that of a perfect electrical conductor. This leads to

Tₕₒₗₑₛ≈disks

T_{disks}≈holes

at A≥600 nm for arrays in air and at A≥900 nm for arrays in glass. Optical properties of arrays in air/glass half-space are more complex and resemble a mix of the air-only and glass-only cases. Interestingly, transmission T is nearly the same for disks and holes at A_{+1,0}^{glass}=640 nm in air/glass half-space. This can be explained by the similarly strong interaction between NDs (NHs) with WRAs, which leads to very similar respective electric field distribution for NDs and NHs (see inset in FIG. 3B). It can thus be inferred that where Dₕ=D_{d}, design using complementary NHs is workable, primarily at specific wavelengths in a half-space geometry.

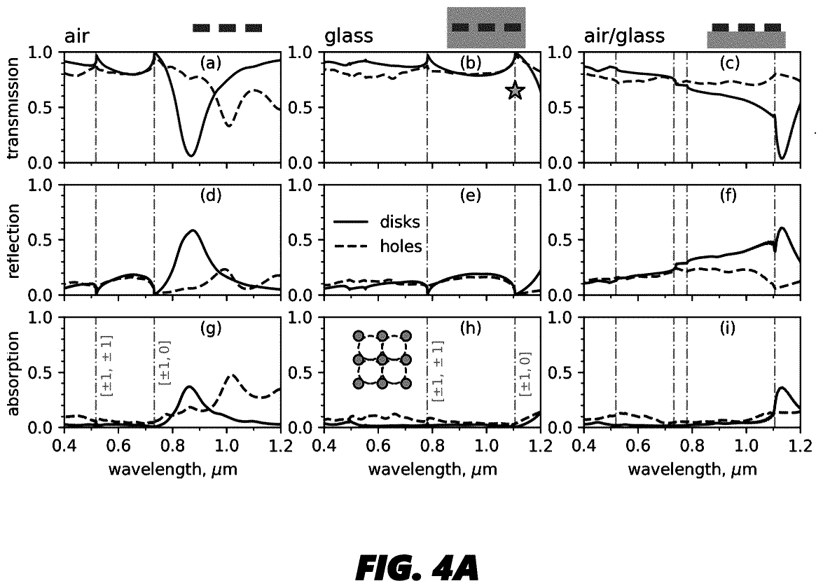

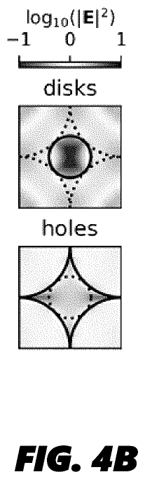

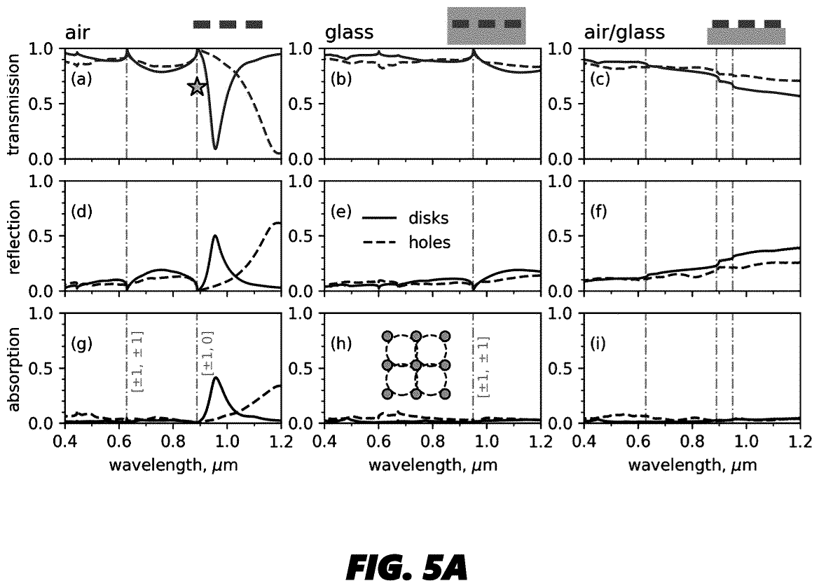

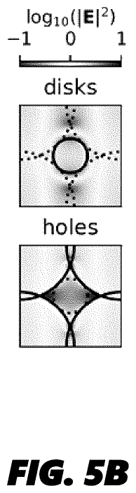

Increasing NH sizes beyond the Dₕ=D_{d} regime, predictably leads to a violation of Babinet's principle, which is observed from transmission and reflection spectra in FIGS. 4A and 5 [symbol] . However, now a distinction between optical properties of NHs and NDs surprisingly becomes less pronounced. For sufficiently large P (see Table 1 in FIG. 2B), most of the interparticle space can be occupied by circular nano-holes, which can make arrays of NP disks and NH holes mutually interchangeable. As a result, at wavelengths below the lowest-order WRA, A<A+_{1,0}, transmission T, reflection R, absorption A, and, most remarkably, near-field features of NP disks and NH holes arrays are almost indistinguishable between each other.

The graphs of FIG. 4A and inset of FIG. 4B show absorption, reflection, and transmission as arranged in FIG. 3A, but for the FIG. 2A case wherein Dₕ=P. That is, the nano-hole diameters Dₕ are substantially equal to the pitch P.

The graphs of FIG. 5A and inset of FIG. 5B show absorption, reflection, and transmission as arranged in FIGS. 3A and 4A, but for the FIG. 2A case wherein Sₕ=S_{d}. That is, the surface area covered by metal is the same for both arrays of holes and disks.

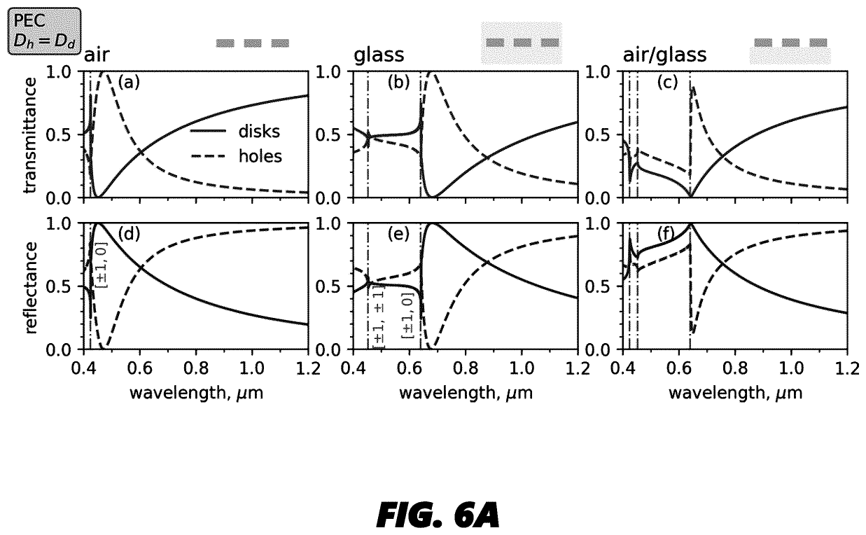

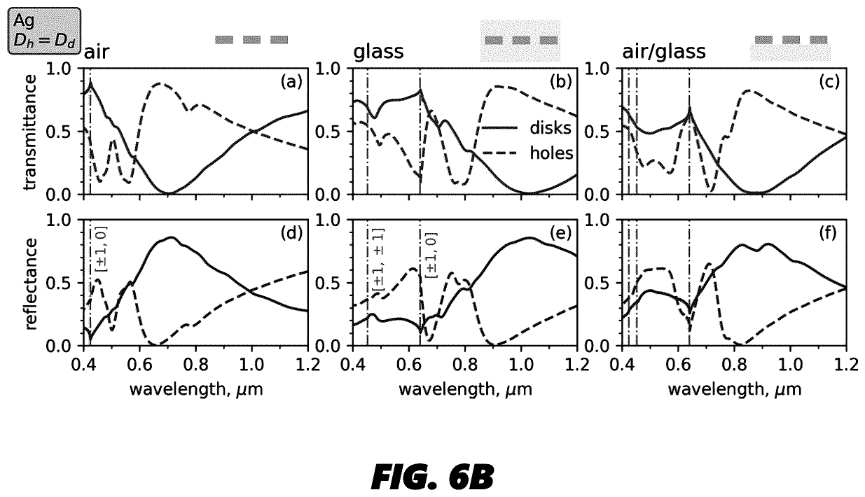

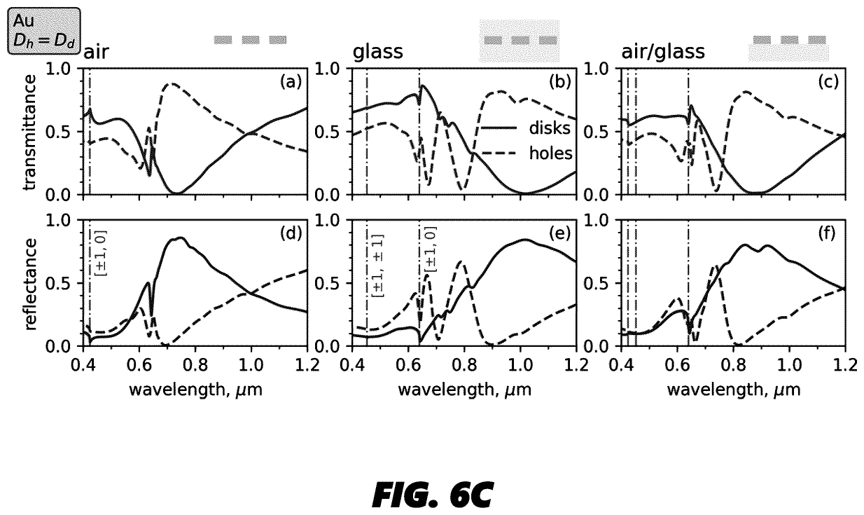

FIG. 6A shows transmittance and reflectance spectra for square arrays of polyelectrolyte complex (PEC) nano-disks (solid lines) and for arrays of holes for the Dₕ=D_{d} case. Dashed vertical lines show spectral positions of the WRAs, λ_{p,q} in air and glass. The combined set of WRAs (both for air and glass media) is shown for the air/glass configuration.

FIG. 6B shows transmittance and reflectance spectra for square arrays of Ag thin-film nano-disks (solid lines) and for arrays of holes for the Dₕ=D_{d} case. Dashed vertical lines show spectral positions of the WRAs, λ_{p,q} in air and glass. The combined set of WRAs (both for air and glass media) is shown for the air/glass configuration.

FIG. 6C shows transmittance and reflectance spectra for square arrays of Au thin-film nano-disks (solid lines) and for arrays of holes for the Dₕ=D_{d} case. Dashed vertical lines show spectral positions of the WRAs, λ_{p,q} in air and glass. The combined set of WRAs (both for air and glass media) is shown for the air/glass configuration.

At non-resonant wavelengths below the lowest-order WRA, λ<λ_{±1.0}, transmittance T and reflectance R of ND and NH arrays can be almost indistinguishable for the materials used, even in the case of half-space geometry, wherein the WRA corresponding to the medium having the lower refractive index sets the threshold for similarity between NHs and NDs. At wavelengths larger than the lowest-order WRA λ>λ_{±1.0}, there can be a strong coherent interaction between NDs (NHs) in array which leads to the manifestation of so-called hybrid collective lattice resonances (CLRs), clearly observed at λ≈λ_{±1.0}. Thus, the wavelength of λ_{±1.0} can be considered a threshold wavelength, distinguishing the regime with dominant non-coherent individual response of NDs (and NHs) for λ<λ_{±1.0} from the regime having dominant coherent collective response of NDs (and NHs).

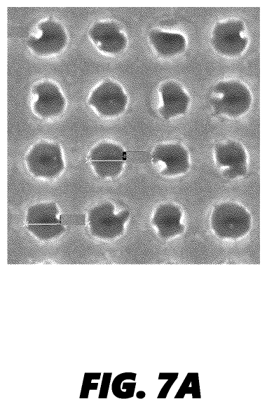

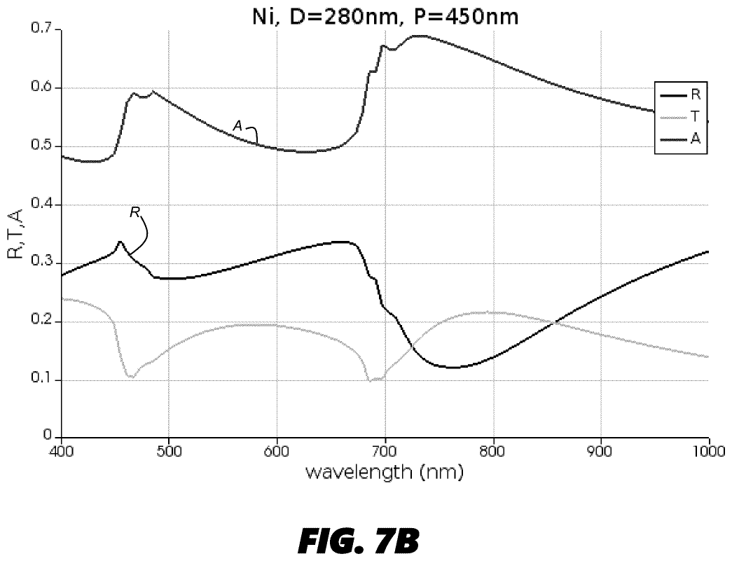

FIG. 7A shows nano-hole array formed in nickel. The graph of FIG. 7B shows reflectance (R), transmission (T), and absorption (A) results for nano-holes (NH) in nickel (Ni), with hole diameter Dₕ at 280 nm and pitch P at 450 nm.

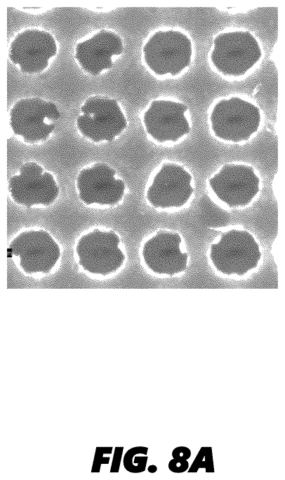

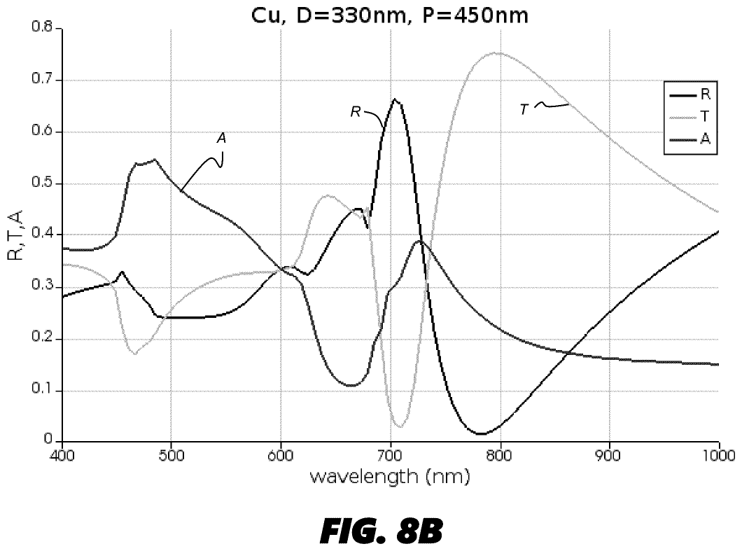

FIG. 8A shows nano-hole array formed in copper. The graph of FIG. 8B shows reflectance (R), transmission (T), and absorption (A) results for nano-holes (NH) in copper (Cu), with hole diameter Dₕ at 330 nm and pitch P at 450 nm.

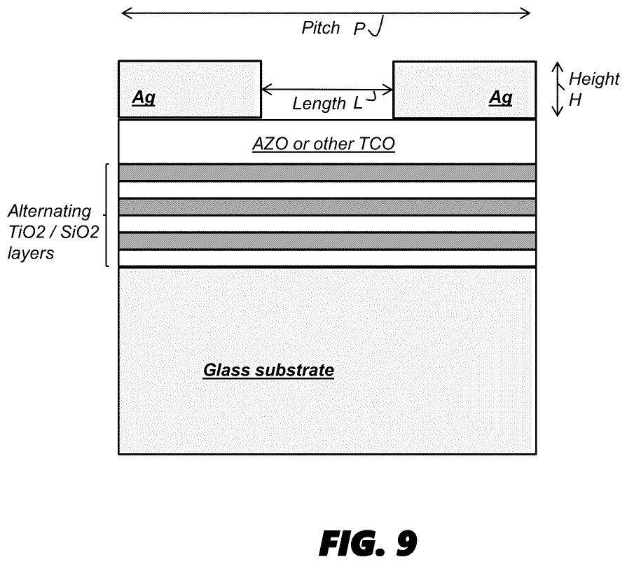

FIG. 9 is a side view schematic that shows an arrangement of layers having nano-holes in a silver coating, with pitch P and length L. The NH features can be formed over a layer of AZO (aluminum-doped zinc oxide) or other transparent conductive oxide (TCO) and over alternating layers of TiO2 and SiO2 on a glass substrate. The alternating multiple layers can form a distributed Bragg reflector, for example. The AZO layer can have a thickness of about 35 nm, for example.

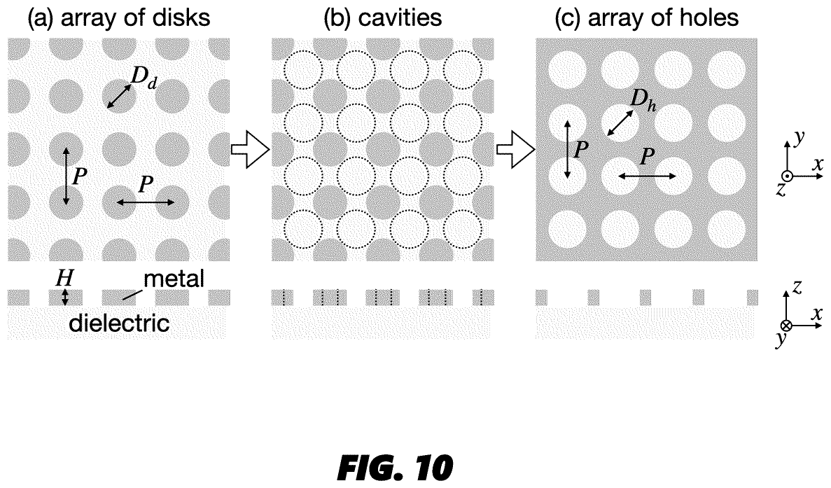

FIG. 10 shows features considered in the design process for using nano-holes NH to provide a plasmonic interface. A regular 2-D array of nano-disks ND can be modeled as shown in FIG. 10 part (a), having diameter D_{d} and pitch P. In FIG. 10 part (b), a corresponding array of cavities can be fitted into the spaces between adjacent nano-disks ND. This array of cavities can then be formed as an array of nano-holes NH in a deposited layer of metal, as in FIG. 10, part (c).

The nano-holes in the complementary array of FIG. 10 part (c) can thus have a diameter:

Dₕ=\sqrt{2}P−D_{d}

The regime of touching holes, i.e. Dₕ=P occurs if:

Dₕ=\sqrt{2}−1)P

In this regime, the Applicant has found that absorption, transmittance, and reflectance (ATR) provided by the array of NHs very closely matches the ATR of NDs.

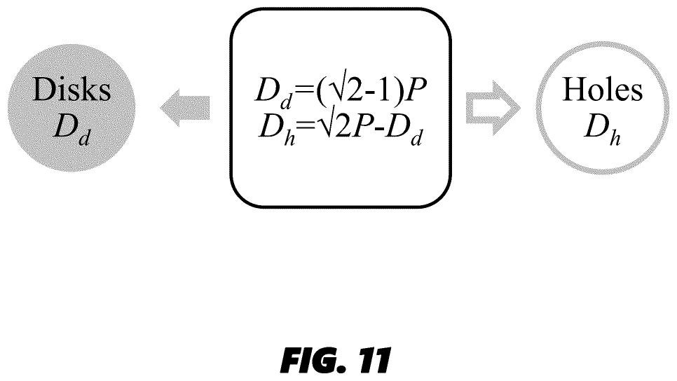

FIG. 11 shows the relation of NDs to NHs for achieving the same basic response in array design. This relationship can allow considerable design flexibility for configuring photonic materials using either NDs or NHs, or combinations of both ND and NH features, as is most convenient.

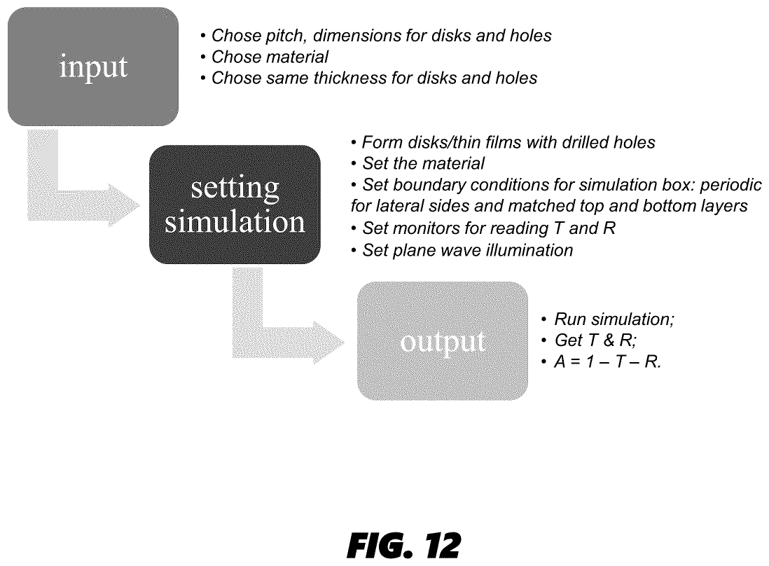

FIG. 12 is a logic flow diagram that shows stages in the design process that can be set up and executed by a numerical FDTD (Finite Difference Time-Domain) application for design of spectral shifting interfaces using NHs or, with minor changes, using a combination of NH and NP features. Input to the process is a determination of variable parameters such as the pitch of nanostructure components, material to be deposited and from which nano-holes or nano-disks or other NPs are to be formed. The holes and disks should be sized equivalently. In a fabrication process, the NDs or NHs can be formed from the desired material. Simulation can be performed, setting a number of boundary conditions. Plane wave illumination is considered for obtaining performance data. Following simulation, transmittance and reflectance (T and R) can be computed. Following this, absorption (A) can be calculated using T and R values.

As is well known in the photonic film design arts, the A-R-T response of nanoparticle structures, as shown in FIGS. 3A, 4A, 5A, for example, provides the needed information on material response for calculations that dictate design and performance for plasmonic features. The Applicant has shown that nano-holes NH and nano-disks ND can be alternative solutions for providing a matrix of sub-wavelength features that enhance plasmonic response. The alternative use of NDs or NHs (or both) allows the photonics interface designer to take advantage of different approaches for nano-structure design, using either ND (or other NP) and NH features interchangeably, or using them in combination to achieve the intended plasmonic response.

Spectral position of localized surface plasmon resonances can be tuned using nanoparticles, nano-disks, or nano-holes of different shapes.

An embodiment of the present disclosure includes photonic films that have been formed for spectral conditioning of light energy, such as for films and related structures that effect down-shifting or up-shifting of the light wavelengths. Such a photonic film, for example, can have an array of nano-holes, suitably spaced and dimensioned to provide a distribution of light energy according to spectral characteristics; alternately, a film can have an array of nano-holes provided with a complementary array of nano-disks, as described herein.

Whereas, the devices and methods have been described in relation to the drawings and claims, it should be understood that other and further modifications, apart from those shown or suggested herein, may be made within the spirit and scope of this disclosure.

The apparatus of the present disclosure has been described in detail with particular reference to a presently preferred embodiment, but it will be understood that variations and modifications can be effected within the spirit and scope of the disclosure. The presently disclosed embodiments are therefore considered in all respects to be illustrative and not restrictive. The scope of the invention is indicated by any appended claims, and all changes that come within the meaning and range of equivalents thereof are intended to be embraced therein.

1. A photonic surface comprising a thin film layer having an array of nano-holes formed within a material, wherein the nano-holes are uniformly dimensioned and distributed to enhance plasmonic response of the material over a range of wavelengths.

2. The photonic surface of claim 1 wherein the material is silver.

3. The photonic surface of claim 1 wherein the material is gold.

4. The photonic surface of claim 1 wherein the material is polyelectrolyte complex (PEC).

5. The photonic surface of claim 1 wherein the nano-hole diameter is less than 300 nm.

6. The photonic surface of claim 1 wherein the thin film layer further comprises an array of nano-disks interspersed with the array of nano-holes.

7. The photonic surface of claim 6 wherein the nano-disks and nano-holes have the same pitch and diameter along the surface.

8. The photonic surface of claim 1 wherein the photonic surface is enclosed within a glass substrate.

9. The photonic surface of claim 1 wherein the photonic surface is formed on a glass substrate.

10. A photonic element comprising:
a surface comprising a thin film layer having a first array of nano-holes formed within a material, wherein the nano-holes have a common first diameter and are distributed to enhance plasmonic response of the material over a range of wavelengths;
and
a distributed Bragg reflector formed of alternating layers of TiO2 and SiO2.

11. The photonic element of claim 10 further having a second array of nano-disks formed of the same material in which the nano-holes are formed.

12. The photonic element of claim 10 further comprising a layer of a transparent conductive oxide between the thin film layer and the distributed Bragg reflector.

13. A method for forming a plasmonic interface surface comprising:
(a) determining a desired spectral response for transmission, reflection, and absorption over a spectral range of incident light at the interface;
(b) calculating diameter dimensions and pitch P for a matrix of an array of nano-holes of diameter dimension Dₕ and height H;
wherein the calculated diameter Dₕ and pitch P dimensions provide the desired spectral response;
(c) depositing a metal layer of thickness H onto a dielectric material for forming the plasmonic interface;
and
(d) forming the array of a nano-holes in the deposited metal layer according to the calculated diameter Dₕ and pitch P.

14. The method of claim 13 further comprising forming an array of nano-disks having a predetermined diameter D_{d} and pitch P in the metal layer, wherein
Dₕ=\sqrt{2}−1)P.

15. The method of claim 13 wherein forming the array of nano-holes comprises using one or more of focused ion beam milling, soft interference lithography, ion-beam planarization, and direct laser writing.

16. The method of claim 13 wherein calculating comprises computing the spectral position of one or more Wood-Rayleigh anomalies.
